(19) United States
(12) Patent Application Publication
(10) Pub. No.: US 2005/0258108 A1
(43) Pub. Date: Nov. 24, 2005

(54) Container with purifier

(76) Inventor: Eric Sanford, White Salmon, WA (US)

Correspondence Address: Eric Sanford, PO Box 1300, Hood River, OR, 97031, US

(21) Appl. No.: 11/136,065

(22) Filed: May 24, 2005

Related U.S. Application Data
(60) Provisional application No. 60/574,060, filed on May 24, 2004.

(51) Int. Cl. C02F 1/32

(52) U.S. Cl. 210/748

(57) ABSTRACT

The invention is a container for purifying water with an integrated solar-powered rechargeable battery and UV-C emitting LED.

### CROSS-REFERENCE TO RELATED APPLICATIONS

This invention claims priority from U.S. Provisional Patent Application Ser. No. 60/574,060, filed May 24, 2004

### FIELD OF THE INVENTION

This invention relates to the field of containers that employ an integrated purifier, preferably comprising an UV LED powered by a rechargeable power source that is energized by solar power.

### SUMMARY OF THE INVENTION

This invention comprises a container for purifying a material comprising a body adapted to contain the material, a lid adapted to releasably seal the body, a purifying unit having a radiation source and a power source, wherein the radiation source is adapted to deliver radiation to the interior of the body for purifying the material. Preferably, the purifying unit is incorporated into the lid.

In one embodiment of the invention, the power source comprises a rechargeable battery. Preferably, the purifying unit further comprises a solar panel configured to deliver energy to the rechargeable battery.

In currently preferred embodiments, the container is adapted to purify a liquid, such as water.

In one embodiment of the invention, the radiation source is an elongate member that extends into the container to improve radiation dispersion. In an alternate embodiment, the radiation source is configured as one or more ribs integrated into the body of the container.

Preferably, the radiation source is one or more LEDs, that emit UV-C radiation. More preferably, the radiation has a wavelength in the range of approximately 200 to 265 nanometers. In the noted embodiments, the radiation source is preferably adapted to delivery approximately 10,000 microwatts per square centimeter to the material.

The invention also comprises a method for purifying a material including the steps of providing a container having a releasably sealing lid and a purifying unit having a solar-powered rechargeable power source that energizes a UV-C emitting LED, placing a material in the container, and exposing the material to radiation from the LED until the material is purified.

The containers of the invention can also be equipped with visible light emitting sources, allowing the container to function as a source of illumination as well as a purifier.

The noted embodiments of the invention may be used inside and outside, in automobiles, for personal safety or for emergency uses. The devices of the invention are especially suitable for backpackers, campers, boaters and other recreational users or the military, for example. The containers provide a system that provides a safe, reliable, durable, long lasting, and energy-efficient means of purifying a wide variety of materials under a wide variety of outdoor and indoor circumstances and conditions.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a schematic cross sectional view of a container embodying a purifying radiation source, according to the invention;

FIG. 2 is schematic cross sectional view of another embodiment, showing an alternate purifying radiation source configuration, according to the invention; and

FIG. 3 is schematic cross sectional view of yet another embodiment, showing another purifying radiation source configuration, according to the invention.

### DETAILED DESCRIPTION OF THE INVENTION

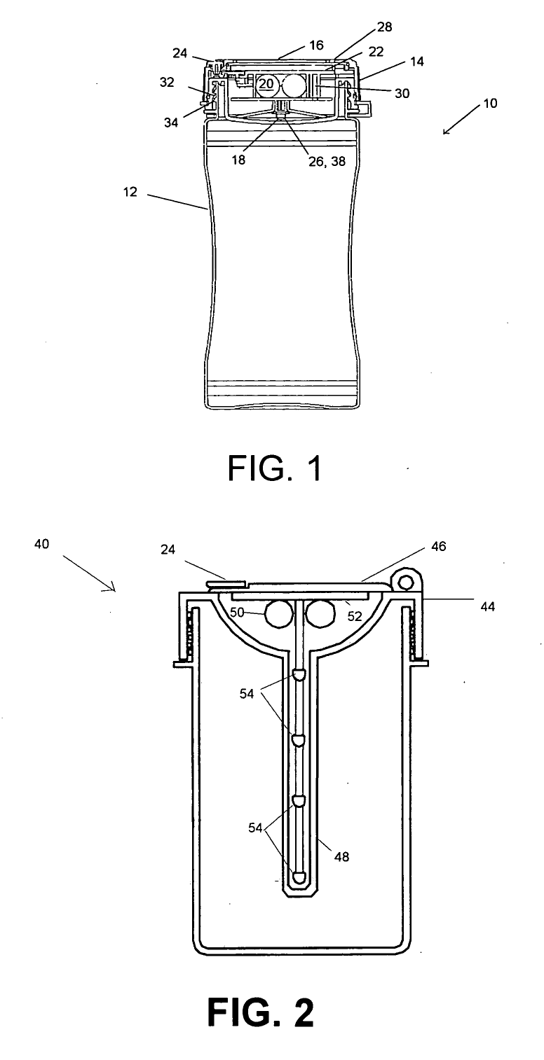

As shown in FIG. 1, a container 10 embodying features of the invention typically comprises body 12 configured to hold liquid with a liquid-tight closure, preferably in the form of lid 14. In this embodiment, solar panel 16, radiation source 18, rechargeable power source 20 and circuitry 22 are integrated into lid 14. Circuitry 22 is used to deliver power from solar panel 16 to rechargeable power source 20 during periods when the device is exposed to sufficient light to generate electricity. Similarly, circuitry 22 also delivers power from rechargeable power source 20 to radiation source 18 when illumination is desired. In this embodiment, a switch 24 can be used to turn radiation source 18 on and off as desired. Radiation source 18 may comprise one or more LEDs 26, depending upon the desired amount and type of radiation. Further, when multiple LEDs are employed, switch 24 can be configured to operate any desired combination of such LEDs.

In another embodiment of the invention, rechargeable power source 20 is not required and circuitry 22 is configured to simply deliver electricity from solar panel 16 to radiation source 18. Thus, when sufficient solar energy is available to operate radiation source 18, it can operate automatically.

A number of suitable LEDs may be used in the practice of the invention. Preferably, an LED that emits UV radiation suitable for water purification is used.

Ultraviolet light disinfects rapidly without the use of heat or chemicals. Ultraviolet light treatment is a proven and accepted method for disinfecting drinking water. The most effect germicidal wavelengths occur in the UV-C range of 200 and 265 nanometers. Microorganisms encompass a wide variety of unique structures and can be grouped into five basic groups: bacteria, virus, fungi, protozoa, and algae. A microorganism is composed of the cell-wall, cytoplasmic membrane and the cell's genetic material, nucleic acid. It is this genetic material or DNA that is affected by UV radiation. As UV-C penetrates through the cell wall, it causes molecular rearrangement of the microorganism's DNA thus preventing reproduction. Due to individual cell makeup, different levels of radiation are required for destruction. The effectiveness of UV microbial destruction is a product of both time and intensity. The intensity of UV-C light is measured in micro-watts per square centimeter and the time is measured in seconds. Thus, the dose is the amount of ultraviolet light necessary to kill a particular microorganism, and can be measured in units of micro-watt seconds per square centimeter. Table 1 shows the amount of UV-C radiation required to kill common microorganisms. Accordingly, one of skill in the art can configure radiation source 18, solar panel 16, rechargeable power source 20 and circuitry 22 to generate the desired level of disinfection.

TABLE 1

| | | | |
|---|---|---|---|
| Bacillus anthracis | 8,700 | Shigella dysentariae (dysentery) | 4,200 |
| Corynebacterium diphtheriae | 6,500 | Shigella flexneri (dysentery) | 3,400 |
| Dysentary bacilli (diarrhea) | 4,200 | Staphylococcus epidermidis | 5,800 |
| Escherichia coli (diarrhea) | 7,000 | Streptococcus faecaelis | 10,000 |
| Legionella pneumophilia | 3,800 | Vibro commo (cholera) | 6,500 |
| Mycobacterium tuberculosis | 10,000 | Bacteriophage (E. Coli) | 6,500 |
| Pseudomonas aeruginosa | 3,900 | Hepatitis | 8,000 |
| Salmonella (food poisoning) | 10,000 | Influenza | 6,600 |
| Salmonella paratyphi (enteric fever) | 6,100 | Poliovirus (poliomyelitis) | 7,000 |
| Salmonella typhosa (typhoid fever) | 7,000 | Baker's yeast | 8,800 |

In the embodiment shown in FIG. 1, intensity of the emitted UV radiation will decrease with distance from LED 26. Therefore, suitable accommodation can be made to determine the appropriate time necessary to disinfect the contents of container 10. For example, if container 10 is moved during the disinfection process, the contents will be agitated and diffuse more rapidly, allowing for faster purification. If container 10 is not moved, more time will generally be required.

In some embodiments, it may be preferable to provide container 10 with an indicator 28 showing when sufficient disinfection has occurred. Indicator 28 can be controlled based upon time alone, or container 10 can further comprise motion sensor 30 so that the purification determination can be configured to compensate for movement the container experiences.

As discussed above, it may be desirable to provide radiation source 18 with a visible LED as well. A currently preferred visible light LED emits substantially white light, such as the LEDs disclosed in U.S. Pat. No. 6,163,038 to Chen, et al., which is hereby incorporated in its entirety by reference. Alternatively, LEDs that produce other wavelengths of light can be used as desired. For example, an LED that emits a yellow light can provide a softer, less glaring illumination that may be preferable for aesthetic purposes. Also, a red LED may be desirable to preserve the user's night vision while still providing illumination. One having skill in the art will recognize that the LEDs used in container 10 could easily be made interchangeable to increase the versatility of the device. Further, two or more LEDs having different characteristics may be employed.

The present invention employs a solar panel 16 that comprises a plurality of electrically connected photovoltaic cells to produce power to charge rechargeable power supply 20. Circuitry 22 should conventionally include an in line blocking diode to prevent current leakage back to solar panel 16 when it is not charging and an in line voltage limiting circuit to prevent overcharging. It may also be desirable to provide a transformer and/or voltage regulator to increase the voltage and keep current steady during operation of the LED.

Rechargeable power supply 20 may comprise any suitable means for storing power from solar panel 16 and delivering that power to radiation source 18. For example, rechargeable batteries as are known in the art can be used. Such batteries may employ various chemistries to achieve the desired performance or maintain the desired economy. Example of rechargeable batteries that are currently preferred include nickel-cadmium, nickel metal hydride, lithium ion and others. Alternatively, capacitors may also be used in the practice of the invention. For example, capacitors of up to 100 farads are available at economical costs and larger storage capacities can be accomplished by adding additional capacitors. In yet another embodiment, container 10 can be configured so that the rechargeable batteries can be removed and replaced with conventional batteries to allow the container to operate when there is insufficient light to power the solar panel.

As shown, lid 14 is removably attached to body 12 by way of threads 32 and 34 molded into the lid and container, respectively. Other means of attaching lid 14 to body 12, such as a snap-fit connection, may be used as desired. In use, a user may carry or store light container 10 throughout the day so that solar panel 16 is exposed to sunlight to charge rechargeable power source 20.

In another embodiment of the invention, an LED 36 that emits visible light is used to allow container 10 to provide illumination as well as water purification. Switch 24 is used to select between modes. In such embodiments, a high efficiency white LED is preferred, as this tends to provide the most natural and versatile light.

Body 12 is preferably molded from one of the well known translucent polymers, e.g., polyethylene, polypropylene, etc. Preferably, a polymer that transmits UV light is used where necessary to allow for efficient irradiation of the container contents. To improve light dispersion, it may be desirable to mold grooves or ridges into the container to function as a lens. These grooves or ridges are preferably situated on the outside of the container to facilitate cleaning.

Additional details regarding suitable containers can be found in co-pending U.S. patent application Ser. No. 11/093,750, filed Mar. 29, 2005, which is hereby incorporated in its entirety by reference.

In another embodiment of the invention, container 40 generally has body 42 and lid 44 as shown in FIG. 2. In this embodiment, solar panel 46, radiation source 48, rechargeable power source 50 and circuitry 52 are integrated into lid 42. Radiation source 48 is an elongate member configured to extend into the interior of body 42, to improve radiation dispersion. Preferably, radiation source 48 extends to about 50% of the depth of container 40, and more preferably, to 75% or more. Radiation source 48 can be configured as necessary to improve irradiation. For example, source 48 can comprise multiple members. LEDs 54 are preferably evenly distributed along radiation source 48 to enhance disinfection.

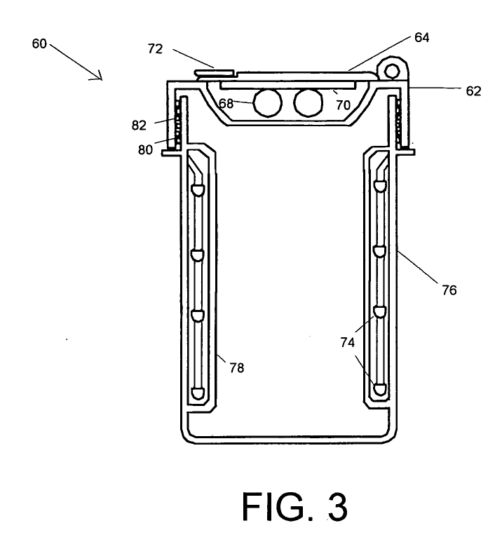

An alternate embodiment of the invention is shown in FIG. 3. This embodiment is container 60, having a lid 62 with integrated solar panel 64, rechargeable power source 68 and circuitry 70. Switch 72 operates to deliver power from rechargeable power source 68 to LEDs 74 that are integrated into container body 76. As shown, body 76 comprises one or more longitudinally oriented ribs 78 that are radially spaced about the container. For example, two, three or four ribs 78 can be used. LEDs 74 are spaced along ribs 78 to provide even irradiation of the container contents. Preferably, ribs 78 are configured to aid agitation of the contents of container 60, improving dispersion of the contents and increasing irradiation efficiency. In this embodiment, power from circuitry 70 is delivered to LEDs 74 through contacts disposed in mating threads 80 and 82 of lid 62 and body 76. In alternative embodiments, all elements of the system, including the solar panel and rechargeable energy source can be integrated into the body, rather than the lid, to avoid the need of providing the detachable electrical connections between the lid and body. In yet other embodiments, the LEDs can be embedded in the body, allowing the interior of the container to be relatively smooth.

Without departing from the spirit and scope of this invention, one of ordinary skill can make various changes and modifications to the invention to adapt it to various usages and conditions. Notable, any container that holds material that may be disinfected is suitable. Additionally, the various components of the invention, including the solar panel, the radiation source, and the rechargeable power source can be integrated into any portion of the container. Alternatively, the components can be made modular and/or removable so that they can be moved from container to container. The only constraint is that at least a portion of the contents of the container is exposed to radiation source to effect purification. As such, these changes and modifications are properly, equitably, and intended to be, within the full range of equivalence of the invention.

1. A container for purifying a material comprising a body adapted to contain the material, a lid adapted to releasably seal the body, a purifying unit having a radiation source and a power source, wherein the radiation source is adapted to deliver radiation to the interior of the body for purifying the material.

2. The container of claim 1, wherein the purifying unit is incorporated into the lid.

3. The container of claim 1, wherein the power source comprises a rechargeable battery.

4. The container of claim 3, wherein the purifying unit further comprises a solar panel configured to deliver energy to the rechargeable battery.

5. The container of claim 4, wherein the purifying unit is incorporated into the lid.

6. The container of claim 1, wherein the material is a liquid.

7. The container of claim 6, wherein the material is water.

8. The container of claim 2, wherein the radiation source comprises an elongate member.

9. The container of claim 1, wherein the radiation source comprises at least one rib along the container.

10. The container of claim 1, wherein the radiation source comprises at least one LED.

11. The container of claim 10, wherein the LED emits UV-C radiation.

12. The container of claim 11, wherein the UV-C radiation has a wavelength in the range of approximately 200 to 265 nanometers.

13. The container of claim 1, wherein the radiation source is adapted to delivery approximately 10,000 microwatts per square centimeter to the material.

14. The container of claim 1, further comprising a visible light source selectively energized by the power source.

15. A method for purifying a material comprising the steps of:
providing a container having a releasably sealing lid and a purifying unit having a solar-powered rechargeable power source that energizes a UV-C emitting LED;
placing a material in the container; and
exposing the material to radiation from the LED until the material is purified.
